(19) United States
(12) Patent Application Publication
(10) Pub. No.: US 2022/0413823 A1
(43) Pub. Date: Dec. 29, 2022

(54) METHODS AND APPARATUSES FOR INSTALLING DEVICE APPLICATION

(71) Applicant: SENSETIME INTERNATIONAL PTE. LTD., Singapore (SG)

(72) Inventors: Jiacheng Wu, Singapore (SG); Shuai Zhang, Singapore (SG); Jinliang Lin, Singapore (SG); Gan Xiao, Singapore (SG)

(21) Appl. No.: 17/364,463

(22) Filed: Jun. 30, 2021

Related U.S. Application Data
(63) Continuation of application No. PCT/IB2021/055788, filed on Jun. 29, 2021.

(30) Foreign Application Priority Data
Jun. 28, 2021 (SG) 10202107092P

(51) Int. Cl. G06F 8/61; G06F 8/65; G06F 9/445; G06F 21/54

(52) U.S. Cl. CPC G06F 8/61; G06F 8/65; G06F 9/44505; G06F 21/54

(57) ABSTRACT

The embodiments of the present disclosure provide a method and apparatus for installing device application. The method is applied in an edge device and includes: receiving an application package issued by a cloud, wherein the application package comprises application resource files respectively corresponding to a plurality of applications; in response to determining that a verification for the application package is passed, installing at least one application on the edge device based on the application resource files. In this method, only one application package is needed for installation, which can improve the efficiency of installing and deploying application software on the device.

### CROSS REFERENCE TO RELATED APPLICATION

This application is a continuation application of International Application No. PCT/IB2021/055788 filed on Jun. 29, 2021, which claims priority to Singapore Patent Application No. 10202107092P, filed on Jun. 28, 2021, entitled “METHODS AND APPARATUSES FOR INSTALLING DEVICE APPLICATION”, the disclosure of which is incorporated herein by reference in its entirety for all purposes.

### TECHNICAL FIELD

The embodiments of the present disclosure relate to the field of computer communication technology, and in particular, to a method and an apparatus for installing device application.

### BACKGROUND

The Internet of Things system is generally composed of a cloud and a group of edge devices. The cloud is responsible for a variety of cloud services such as data storage, device control, and business logic processing. The edge devices are responsible for providing interactive operation services to end users. According to different demand scenarios, different applications may run on an edge device. The applications collaboratively work with corresponding cloud services to process different businesses, and each application has an independent software version number.

Generally, the applications are installed on the edge device by installing each application with a corresponding version. Before each application is installed and deployed, it is required to manually check whether the application needs to be installed, and the efficiency of deployment and installation is relatively low.

### SUMMARY

In view of this, the embodiments of the present disclosure provide a method and an apparatus for installing device application.

In a first aspect, a method of installing device application provided, the method is applied to an edge device, and the method includes:

receiving an application package issued by a cloud, wherein the application package comprises application resource files respectively corresponding to a plurality of applications; in response to determining that a verification for the application package is passed, installing at least one application on the edge device based on the application resource files.

In some embodiments, the application package further comprises an application list; the application list comprises: application identifiers of the plurality of applications and respective software version numbers corresponding to the application identifiers; installing the at least one application on the edge device based on the application resource files comprises: traversing each of the application identifiers in the application list, and comparing a first version number with a second version number which are correspond to the application identifier, wherein the first version number is a software version number of a local application corresponding to the application identifier, and the second version number is a software version number corresponding to the application identifier in the application list; in response to the first version number being different from the second version number, obtaining and installing an application resource file corresponding to the application identifier from the application package, so as to upgrade the local application to an application corresponding to the second version number.

In some embodiments, the application package further comprises: an identification code which is generated based on the application resource files, determining that the verification for the application package is passed includes: obtaining a verification code based on the application resource files of the application package; in response to the verification code being consistent with the identification code, determining that the verification for the application package is passed.

In some embodiments, the application package further includes a first application package version number for identifying the application package; determining that the verification for the application package is passed includes: in response to the first application package version number being different from a local second application package version number of the edge device, determining that the verification for the application package is passed, and the second application package version number is an identifier of an application package received the edge device last time by.

In some embodiments, the method further includes: updating the local second application package version number of the edge device to the first application package version number.

In a second aspect, another method of installing device application method is provided. The method is applied in a cloud and includes: generating an application package based on application resource files respectively corresponding to a plurality of applications; issuing the application package to an edge device for the edge device to, in response to that determining a verification for the application package is passed, install at least one application on the edge device based on the application resource files.

In some embodiments, generating the application package based on the application resource files respectively corresponding to the plurality of applications includes: generating an application list based on respective application identifiers of the plurality of applications and respective software version numbers corresponding to the application identifiers; generating the application package based on the application list and the application resources files.

In some embodiments, generating the application package based on the application resource files respectively corresponding to the plurality of applications includes: generating an identification code based on the application resource files respectively corresponding to the plurality of applications; generating the application package based on the identification code and the application resource files respectively corresponding to the plurality of applications.

In some embodiments, generating the application package based on the application resource files respectively corresponding to the plurality of applications includes: generating a first application package version number corresponding to the application package, wherein the first application package version number identifies the application version number; and generating the application package based on the first application package version number and the application resource files respectively corresponding to the plurality of applications.

In some embodiments, the plurality of applications include a first application and a second application with a dependency relationship; generating the application package based on the application resource files respectively corresponding to the plurality of applications includes: generating the application package based on at least one application resource file corresponding to the first application and at least one application resource file corresponding to the second application.

In a third aspect, an apparatus for installing device application is provided, the apparatus is applied to an edge device and includes: an application receiving module, configured to receive an application package issued by a cloud, wherein the application package includes application resource files respectively corresponding to a plurality of applications; and an application installing module, configure to, in response to determining that a verification for the application package is passed, install at least one application on the edge device based on the application resource files.

In some embodiments, the application package further includes an application list; the application list includes: application identifiers of the plurality of applications and respective software version numbers corresponding to the application identifiers; when the application installing module is configured to install the at least one application on the edge device based on the application resource files, including: traversing each of the application identifiers in the application list, and comparing a first version number with a second version number which are correspond to the application identifier, wherein the first version number is a software version number of a local application corresponding to the application identifier, and the second version number is a software version number corresponding to the application identifier in the application list; in response to the first version number being different from the second version number, obtaining and installing an application resource file corresponding to the application identifier from the application package, so as to upgrade the local application to an application corresponding to the second version number.

In some embodiments, the application package further includes: an identification code which is generated based on the application resource files, when the application installing module is configured to determine that the verification for the application package is passed, including: obtaining a verification code based on the application resource files of the application package; in response to the verification code being consistent with the identification code, determining that the verification for the application package is passed.

In some embodiments, the application package further includes a first application package version number for identifying the application package; when the application installing module is configured to determine that the verification for the application package is passed, including: in response to the first application package version number being different from a local second application package version number of the edge device, determining that the verification for the application package is passed, and the second application package version number is an identifier of an application package received by the edge device last time.

In some embodiments, the apparatus further includes: a version number updating module, configured to update the local second application package version number of the edge device to the first application package version number.

In a fourth aspect, another apparatus for installing device application is provided. The apparatus is applied in a cloud and includes: an application package generating module, configured to generate an application package based on application resource files respectively corresponding to a plurality of applications; an application issuing module, configured to issue the application package to an edge device for the edge device to, in response to determining that a verification for the application package is passed, install at least one application on the edge device based on the application resource files.

In some embodiments, the application package generating module is specifically configured to: generate an application list based on respective application identifiers of the plurality of applications and respective software version numbers corresponding to the application identifiers; generate the application package based on the application list and the application resources files.

In some embodiments, the application package generating module is specifically configured to: generate an identification code based on the application resource files respectively corresponding to the plurality of applications; and generate the application package based on the identification code and the application resource files respectively corresponding to the plurality of applications.

In some embodiments, the application package generating module is specifically configured to: generate a first application package version number corresponding to the application package, wherein the first application package version number identifies the application version number; and generate the application package based on the first application package version number and the application resource files respectively corresponding to the plurality of applications.

In some embodiments, the plurality of applications include a first application and a second application with a dependency relationship; the application package generating module 101 is specifically configured to: generate the application package based on at least one application resource file corresponding to the first application and at least one application resource file corresponding to the second application.

In a fifth aspect, a computer program product is provided, including a computer program/instruction, wherein when the computer program/instruction is executed by a processor, the method of installing device application according to any of the embodiments of the present disclosure is implemented.

In a sixth aspect, an electronic device is provided, including a memory, a processor, wherein the memory is configured to store computer instructions that can run on the processor. When the computer instructions are executed by the processor, the method of installing device application according to any of the embodiments of the present disclosure is implemented.

In a seventh aspect, a computer readable storage medium is provided, having a computer program stored thereon, wherein in a case that the computer program is executed by a processor, the method of installing device application according to any of the embodiments of the present disclosure is implemented.

According to the method and apparatus for installing device application provided by the embodiments of the present disclosure, an application package is issued by a cloud and verified by an edge device such that applications could be installed in batches. The edge device may complete applications installation based on only one application package, which can improve the efficiency of installing and deploying software on the device.

### BRIEF DESCRIPTION OF THE DRAWINGS

To explain the technical solutions in one or more embodiments of the present disclosure or in related art more clearly, the drawings used in the description of the embodiments or related art will be briefly introduced below. Apparently, the drawings in the following description are only one or more embodiments of the present disclosure. For those of ordinary skill in the art, other embodiments can be obtained based on these drawings without creative effort.

FIG. 1 is a flowchart illustrating a method of installing device application according to some embodiments of the present disclosure.

FIG. 2 is a flowchart illustrating another method of installing device application according to some embodiments of the present disclosure.

FIG. 3 is a flowchart illustrating still another method of installing device application according to some embodiments of the present disclosure.

FIG. 4 is a flowchart illustrating yet another method of installing device application according to some embodiments of the present disclosure.

FIG. 5 is a flowchart illustrating a method of installing device application according to some embodiments of the present disclosure.

FIG. 6 is a flowchart illustrating a method of installing device application under a scenario of a gaming place according to some embodiments of the present disclosure.

FIG. 7 is a schematic diagram of an application package generated by a cloud according to some embodiments of the present disclosure.

FIG. 8 is a block diagram illustrating an apparatus for installing device application according to some embodiments of the present disclosure.

FIG. 9 is a block diagram illustrating another apparatus for installing device application according to some embodiments of the present disclosure.

FIG. 10 is a block diagram illustrating still another apparatus for installing device application according to some embodiments of the present disclosure.

FIG. 11 is a schematic hardware structural diagram of an electronic device according to some embodiments of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in this disclosure are only for the purpose of describing specific embodiments, and are not intended to limit the disclosure. The singular forms of “a”, “said” and “the” used in this specification and appended claims are also intended to include plural forms, unless the context clearly indicates other meanings. It should also be understood that the term “and/or” as used herein refers to and includes any or all possible combinations of one or more associated listed items.

It should be understood that although the terms first, second, third, etc. may be used in this disclosure to describe various information, the information should not be limited to these terms. These terms are only used to distinguish the same type of information from each other. For example, without departing from the scope of this specification, the first information may also be referred to as second information, and similarly, the second information may also be referred to as first information. Depending on the context, the word “if” as used herein can be interpreted as “when” or “while” or “in response to determining”.

As shown in FIG. 1, which is a flowchart illustrating a method of installing device application according to some embodiments of the present disclosure. The method may be applied in an edge device and includes the following steps.

At step 100, an application package issued by a cloud is received, wherein the application package includes application resource files respectively corresponding to a plurality of applications.

According to different demand scenarios, different applications may run on the edge device to provide services to an end user. These applications work with corresponding cloud services to process different businesses in parallel. For long-term iterative edge devices, demand scenarios may change constantly, and the applications on the edge device also need to be constantly changed and upgraded. Each application has an independent software version number, and the upgrade may change the software version number of the corresponding application.

The edge device can receive an application package in various situations where applications need to be installed. The edge device can request the application package from the cloud and then the cloud can issue the application package, or the cloud can actively issue the application package to the edge device.

Specifically, when the demand scenario of the edge device changes or the application needs to be upgraded, for example, the edge device can request the corresponding application package from the cloud for upgrade after receiving an upgrade request from the user, or when the operation and maintenance personnel of the cloud want to adjust the function of the edge device, the corresponding application package can be issued by the cloud, or when a hardware on the edge device is replaced and the previous application does not match the new hardware, the corresponding application package can be requested from the cloud, etc.

The application package may include application resource files respectively corresponding to a plurality of applications. Under different application scenarios, different applications need to be installed on the edge device, and the application resource file required to install each application is also different, that is, application packages corresponding to different demand scenarios are different. The operation and maintenance personnel can construct different application packages in the cloud according to different demand scenarios in advance. Or, when an application on the edge device needs to be upgraded, the operation and maintenance personnel may construct the corresponding application package in the cloud in advance based on the application resource files respectively corresponding to a plurality of upgraded versions of the application.

The application resource file of each application is the resource required to install the corresponding application, which may include but is not limited to: application installation tools, configuration files, and image resources. The application resource files respectively corresponding to different versions of an application are also different.

In addition, the applications in the application package may not only be the applications that need to be installed on the edge device, but also other applications that these applications depend on.

At step 102, in response to determining that a verification for the application package is passed, at least one application is installed on the edge device based on the application resource files.

After receiving the application package, the edge device can verify the application package in various ways to achieve different effects. This embodiment does not limit the specific verification method.

For example, the application package can be a file encrypted by the cloud in a specific way. The cloud pre-determines different decryption methods with different edge devices. If an edge device can decrypt the application package in accordance with the agreed decryption method, it means this application package is issued by a legal cloud to the edge device, and the verification is passed. At the same time, it can also prevent installation errors caused by the cloud sending the application package to the wrong edge device. Or, the application package can carry a verification code. The cloud pre-determines different check codes with different edge devices. If the check code in the application package is consistent with the agreed verification code, the verification is passed, and the same effect can be achieved. For another example, the installation is performed after verifying the integrity of the application resource file in the application package to ensure that the application is installed correctly.

In this step, after the verification is passed, the application package is parsed to obtain the application resource file, and the corresponding application installation is performed. After the installation is completed, the software version number of the application on the edge device is changed accordingly. When installing an application, according to the needs of the edge device, it may be one application among the plurality of applications in the application package, or at least two applications of among the plurality of applications in the application package.

In an example, in an application upgrade scenario on the edge device, the software version numbers of the applications app1, app2, and app3 running on the edge device before the upgrade are v0.0.1, v0.0.2, and v0.0.3, respectively. The application package including the application resource files respectively corresponding to the upgraded app1, app2, and app3 can be construct in the cloud and issued to the edge device, so that the edge device can upgrade and install app1, app2 and app3 according to the corresponding application resource file after receiving the application package, the software version numbers of the upgraded applications app1, app2, and app3 are v0.1.1, v0.1.2, and v0.1.3, respectively. It should be noted that during the application upgrade installation process, the edge device can still use the application package to start installing the previous application version, and start to use the newly installed application version until the applications corresponding to the application package are installed, which is a smooth way to upgrade.

According to the method of installing device application provided by the embodiments of the present disclosure, an application package is issued through a cloud and applications are installed in batches after verified by an edge device. The edge device only needs to install based on one application package, which can improve the efficiency of installing and deploying software on the device.

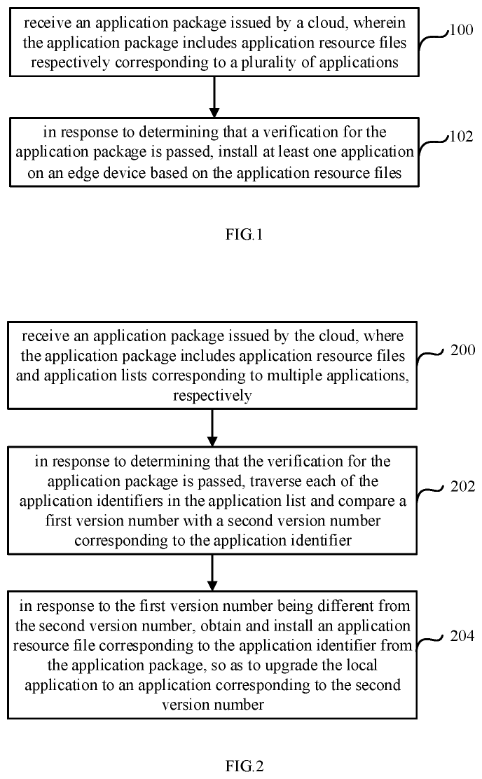

As shown in FIG. 2, which is a flowchart illustrating another method of installing device application according to some embodiments of the present disclosure. The method may be applied in an edge device and includes the following steps. The same steps as the process in FIG. 1 will not repeat here.

At step 200, an application package issued by the cloud is received, where the application package includes application resource files and application lists corresponding to multiple applications, respectively.

The application list includes: application identifiers of the plurality of applications and respective software version numbers corresponding to the application identifiers; The application identifier is the name of the application, which can be any combination of characters such as app1 and app2. The software version number is used to indicate the version of the application. Each application has an independent software version number. The software version number will be changed every time the application is upgraded. For example, a software version number of app3 is v1.3, after the upgrade, the software version number of app3 is v2.3, and this embodiment does not limit the specific form of the software version number.

In this step, the application package received from the cloud includes application resource files and application lists corresponding to multiple applications, respectively. Application resource files respectively corresponding to different applications can also be identified by the application identifiers. For example, the name of the installation tool in the application resource file corresponding to app1 can be app1-installer, the name of the configuration file in the application resource file corresponding to app2 can be app2-config, and the name of the image resource in the application resource file corresponding to app3 can be app3-image.

The application list records the application identifier and software version number of each application corresponding to the application resource file. Exemplarily, the application list shown in Table 1 below:

TABLE 1
Example of application list

| Application identifier | Software version number |
|---|---|
| app1 | v0.2.1 |
| app2 | v0.2.2 |
| app3 | v0.1.3 |
| app4 | NT 5.0 |

At step 202, in response to determining that the verification for the application package is passed, the application list is traversed, and a first version number is compared with a second version number corresponding to the application identifier.

The first version number is a software version number of a local application corresponding to the application identifier, and the second version number is a software version number corresponding to the application identifier in the application list;

After the verification of the application package is passed, the edge device parses the application package to obtain the application resource files and application list in the application package. The edge device can traverse each of the application identifiers in the application list and compare with the local application to determine the application that needs to be installed.

The application running locally on the edge device also has an application identifier and a software version number. The application identifier of the local application can be first compared with the application identifier in the application list. When there is an application identifier that exists in the application list but does not exist in the local application, it is determined that the application corresponding to the application identifier needs to be installed, and the application resource file corresponding to the application identifier can be obtained and installed.

In this step, while traversing each of the application identifiers in the application list, when an application identifier that exists in the application list also exists in the local application, compare the version number of the local application corresponding to the application identifier with the version number in the application list, that is, compare the first version number with the second version number.

At step 204, in response to the first version number being different from the second version number, an application resource file corresponding to the application identifier is obtained from the application package and installed, so as to upgrade the local application to an application corresponding to the second version number.

When the first version number is different from the second version number, it means that the local version of the application is different from the version of the application in the application package, and the local version of the application needs to be upgraded to the version of the application in the application package, then the application resource file corresponding to the application identifier is obtained from the application package and installed The upgrade of the application version can be a version upgrade, a version rollback, or a version series replacement.

For example, the application identifier of the local application and the corresponding software version number may be as shown in Table 2 below:

TABLE 2
Examples of local applications

| Application Identifier | Software version number |
|---|---|
| app1 | v0.1.1 |
| app2 | v0.1.2 |
| app3 | v0.1.3 |

When the edge device traverses the application list as shown in Table 1, it is determined that, after comparison, the application having the same application identifier in the local application and the application list in Table 2 is app3. The first version number and the second version number corresponding to app1 and app2 are different. Then the application resource files respectively corresponding to app1 and app2 are obtained from the application package and installed, so as to upgrade the local v0.1.1 version of appl to v0.2.1, and upgrade the local v0.1.2 version of app2 to v0.2.2. The first version number and the second version number corresponding to app3 are the same, so there is no need to upgrade. Through comparison, it is determined that app4 existing in the application list does not exist in the local application, so the application resource file corresponding to app4 is obtained from the application package and installed.

In the method of installing device application provided by the embodiments of the present disclosure, when installing, deploying or upgrading an application version on an edge device, only one application package needs to be issued through the cloud. After the verification is passed, the edge device automatically traverses the application list to obtain the applications need to be installed and install the locally required version of applications in batches. Compared with other methods of manually checking whether an updated version is needed when installing and deploying each application, the installation efficiency is significantly improved.

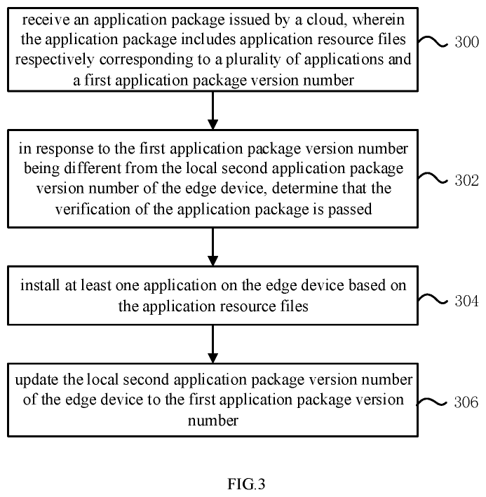

As shown in FIG. 3, which is a flowchart illustrating another method of installing device application according to some embodiments of the present disclosure. The method may be applied in an edge device and includes the following steps. The same steps as the process in FIG. 1 will not repeat here.

At step 300, an application package issued by a cloud is received, wherein the application package includes application resource files respectively corresponding to a plurality of applications and a first application package version number.

The first application package version number identifies the application package.

According to different demand scenarios, the application packages used are different, and even the application packages used in different periods are also different. Multiple application packages will be constructed in the cloud in advance, and each of the application packages may set with a version number for management, that is the first application package version number. The first application package version number of each application package is different. The first application package version number may be represented by various character combinations. In this example, the first application package version number of the application package received by the edge device may be v0.0.0003.

At step 302, in response to the first application package version number being different from the local second application package version number of the edge device, determine that the verification of the application package is passed.

The second application package version number is the identifier of the application package received by the edge device last time.

If the local application of the edge device is installed through the last received application package, that is, the last application package issued to the edge device from the cloud, then the local second application package version number of the edge device is the identifier of the last received application package.

In the case that the first application package version number is different from the second application package version number, or the edge device does not have the second application package version number locally, that is, the application is installed for the first time, the verification of the application package passes. In this way, repeated installation of the same version of the application on the edge device can be prevented.

At step 304, at least one application is installed on the edge device based on the application resource files.

In this step, after the verification is passed, the application package is parsed to obtain the application resource files, and the corresponding application installation is performed. After the installation is completed, the software version number of the application on the edge device is changed accordingly.

In addition, in the case where the application package also includes an application list, the method shown in FIG. 2 can be used for installation.

At step 306, the local second application package version number of the edge device is updated to the first application package version number.

After the application is installed, that is, after the software version number of the local application of the edge device is updated to the software version number of the application in the application package, the local second application package version number of the edge device is updated to the first application package version number. For example, before the installation, the local second application package version number of the edge device is v0.0.0002 of the previous application package, which after the installation, is updated to the first application package version number v0.0.0003.

In the method of installing device application provided by the embodiments of the present disclosure, a first application package version number is used in the cloud to manage multiple application versions installed on a certain edge device, thereby effectively isolating the software version numbers of the applications used by the edge device under different demand scenarios. Compared with other technologies, when dealing with different demand scenarios, it is necessary to manage the software version numbers corresponding to all applications in each demand scenario. Too many software version numbers can easily cause confusion, and the error rate is relatively high. In this method, for an edge device, the cloud only needs to maintain one first application package version number and does not need to care about the separate software version number of each application version, which greatly reduces confusion and errors and improves the accuracy of installation. After the edge device verifies the application package, the applications are installed in batches. The edge device only needs to install based on one application package, which can improve the efficiency of installing and deploying software on the edge device.

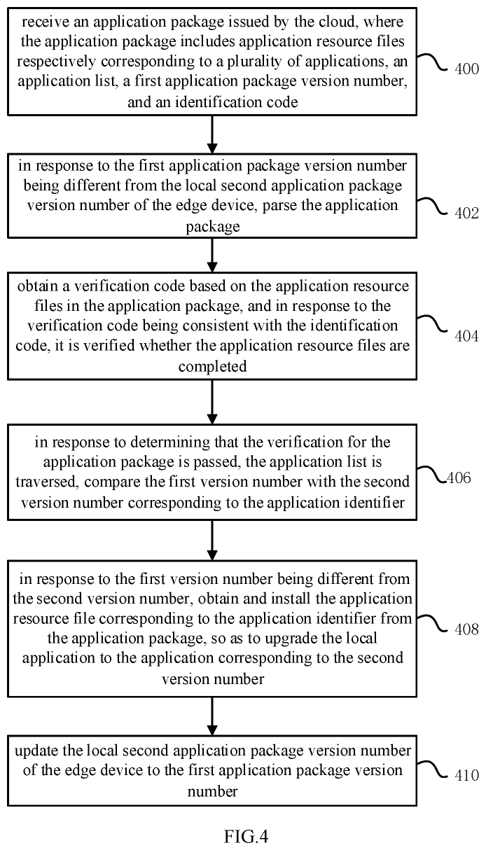

As shown in FIG. 4, which is a flowchart illustrating another method of installing device application according to some embodiments of the present disclosure. The method may be applied in an edge device and includes the following steps. The same steps as the process in the above embodiments will not repeat here.

At step 400, an application package issued by the cloud is received, where the application package includes application resource files respectively corresponding to a plurality of applications, an application list, a first application package version number, and an identification code.

The identification code is generated based on the application resource files in the application package and used by the edge device to verify the application package. It can be used to verify the integrity of the application resource files in the application package, or it can be used to verify the legality of the application package. When the cloud generates the application package, it can calculate the application resource files according to an algorithm agreed with the edge device in advance to generate the identification code. For example, it may be a hash algorithm, such as the sha256 algorithm, and the hash value calculated through the sha256 algorithm with the application resource files as the input is used as the identification code. Other encryption algorithms can also be used to obtain the identification code, such as the MD5 algorithm. This embodiment does not limit the specific algorithm used.

At step 402, in response to the first application package version number being different from the local second application package version number of the edge device, the application package is parsed.

The second application package version number is the identifier of the application package received by the edge device last time.

In this step, in the case where the first application package version number is different from the second application package version number, or in the case that the edge device does not have the second application package version number locally, the application package is parsed. Generally, the cloud will compress application resource files to reduce the size of the application package. When parsing the application package, the compressed application resource files can be decompressed. After the application package is parsed, the application resource files respectively corresponding to the plurality of applications, the application list, the first application package version number, and the identification code are obtained.

If the first application package version number is the same as the second application package version number, the process is ended and no more installation is performed.

At step 404, a verification code is obtained based on the application resource files in the application package, and in response to the verification code being consistent with the identification code, it is verified whether the application resource files are complete.

In this step, the application resource files can be calculated by an algorithm agreed with the cloud in advance to obtain the verification code. For example, following the above example, when the algorithm agreed with the cloud is the sha256 algorithm, the edge device also uses the sha256 algorithm to calculate the verification code and compare it with the identification code to verify whether the application resource file is complete. When the verification code is the same as the identification code, it means that the application resource files are complete files sent by the cloud and is not damaged during the transmission process. At the same time, it can prevent mistakenly installing the application package sent to other edge devices.

If the verification code is inconsistent with the identification code, the process is ended and no more installation is performed.

In addition, the application list can be compared with the application resource files to further verify whether the application resource files are complete. For example, if the corresponding application resource files corresponding to the application identifiers in the application list can all be found, it means that the application resource files are complete; if there is an application identifier in the application list and the corresponding application resource file cannot be found, it means the application resource files are incomplete.

At step 406, in response to determining that the verification for the application package is passed, the application list is traversed, and the first version number is compared with the second version number corresponding to the application identifier.

In the case that the application resource files are complete, the verification of the application package is passed. The edge device can traverse the application list and compare with the local application to determine the application that needs to be installed.

If the application resource files are incomplete, the verification fails, and the process ends, the installation is no longer performed.

At step 408, in response to the first version number being different from the second version number, the application resource file corresponding to the application identifier is obtained from the application package and installed, so as to upgrade the local application to the application corresponding to the second version number.

At step 410, the local second application package version number of the edge device is updated to the first application package version number.

The steps that are the same as those in the foregoing embodiment will not be repeated here.

In the method of installing device application provided by the embodiments of the present disclosure, a first application package version number is used in the cloud to manage multiple application versions installed on a certain edge device, thereby effectively isolating the software version numbers of the applications used by the edge device under different demand scenarios. The cloud sends an application package to the edge device. After the verification is passed, the edge device automatically traverses the application list to obtain the applications that need to be installed, and installs the local default version of applications in batches, which can improve the efficiency of installing and deploying software on an edge device. In this method, for an edge device, the cloud only needs to maintain one first application package version number and does not need to care about the separate software version number of each application version, which greatly reduces confusion and errors and improves the accuracy of installation.

As shown in FIG. 5, which is a flowchart illustrating a method of installing device application according to some embodiments of the present disclosure. The method may be applied in a cloud and includes the following steps.

At step 500, an application package is generated based on application resource files respectively corresponding to a plurality of applications.

In the cloud, multiple edge devices can be managed, and when different edge devices face different demand scenarios or in different periods, different applications need to be deployed on the edge devices. The cloud can construct an application package based on application resource files respectively corresponding to a plurality of applications which that the edge device needs to install. When constructing the application package, the operation and maintenance personnel can select the software version number of each application in the application package. After the cloud receives the applications and the corresponding software version numbers specified by the operation and maintenance personnel, the cloud generates the application package based on the application resource files respectively corresponding to the applications.

Specifically, in the cloud, the application package can be constructed based on the application resource files respectively corresponding to higher-level version of the applications on a certain edge device; or the application package can be construct in advance before the hardware of the edge device is replaced to include application resource files respectively corresponding to the plurality of applications that match the new hardware.

In addition, the application package may also include at least one of the following: an application list, a first application package version number, and an identification code.

At step 502, the application package is issued to an edge device for the edge device to, in response to determining that a verification for the application package is passed, install at least one application on the edge device based on the application resource files.

The cloud can issue the application package to the edge device when the time set by the operation and maintenance personnel is reached. In actual implementation, according to business demands, a same application package can be issued to a plurality of edge devices. Also, the application package can also be issued to the edge device when receiving a request sent by the edge device to the cloud.

When receiving the application package, the edge device verifies the application package to determine the security and integrity of the application package. After the verification is passed, one or more applications are installed on the edge device at a time based on the application resource files, so as to realize the various functions of the edge device.

According to the method for installing device application provided by the embodiments of the present disclosure, an application package is issued through a cloud and applications are installed in batches after verified by an edge device. The edge device only needs to install based on one application package, which can improve the efficiency of installing and deploying software on the device.

In this embodiment, the application package is generated based on the application resource files respectively corresponding to the plurality of applications and includes at least one of the following: an application list, a first application package version number and an identification code. The following examples are several examples of generating the application package. The specific implementation is not limited to the following examples:

In an example, the cloud generates an application list based on respective application identifiers of the plurality of applications and respective software version numbers corresponding to the application identifiers, and generates the application package based on the application list and the application resources files. After the cloud receives the applications and the corresponding software version numbers specified by the operation and maintenance personnel, the cloud can generate an application list. For example, the application list as shown in Table 1.

In this example, the edge device can automatically traverse the application list to obtain the applications that need to be installed, and install the local default application versions in batches, which can improve the efficiency of installing and deploying software on the edge device.

In an example, an identification code is generated based on the application resource files respectively corresponding to the plurality of applications. When the cloud generates the application package, it can calculate the application resource files according to a algorithm agreed with the edge device in advance to generate an identification code, and generate the application package based on the identification code and the application resource files respectively corresponding to the plurality of applications.

In this example, the edge device can verify the identification code through the same algorithm to ensure that the application resource files are complete files sent by the cloud and are not damaged during the transmission process. At the same time, it can prevent mistakenly installing the application package sent to other edge devices.

In an example, generating the application package based on the application resource files respectively corresponding to the plurality of applications further includes: generating a first application package version number corresponding to the application package, wherein the first application package version number identifies the application version number and generating the application package based on the first application package version number and the application resource files respectively corresponding to the plurality of applications. For the cloud, it is necessary to record the corresponding software version numbers of all applications on different edge devices in different demand scenarios and different periods. When installing and deploying applications on edge devices, too many software version numbers can easily cause confusion and the error rate is relatively high.

This example can improve the installation and deployment of a plurality of applications in the cloud to edge devices. For a demand scenario, only one first application package version number needs to be managed.

In an example, the plurality of applications include a first application and a second application with a dependency relationship. The application package is generated based on at least one application resource file corresponding to the first application and at least one application resource file corresponding to the second application. The dependency relationship means that the first application can only work normally when the second application is running. For example, the plurality of applications in the application package may be app1, app2, app3, app4, app5, app7, and app8, where app 1, app2, and app5 are applications that need to be installed to implement the corresponding functions of the edge device. However, the app1 can only work normally when app3, app4, app7 and app8 are running, that is, the first application is app1, and the second applications are app3, app4, app7, and app8. When generating the application package, not only the applications required by the edge device but also the applications that these applications depend on are required to ensure that the edge device can provide services normally.

This example can solve the dependency problem of applications on the edge device by setting dependent applications in the same application package to prevent some applications on the edge device from failing to run normally due to lack of dependent applications.

In a specific implementation manner, the method of installing device application shown in the embodiments of the present disclosure may be applied to a centralized system of a gaming place, and the centralized system of the gaming place may include a cloud and a plurality of gaming devices.

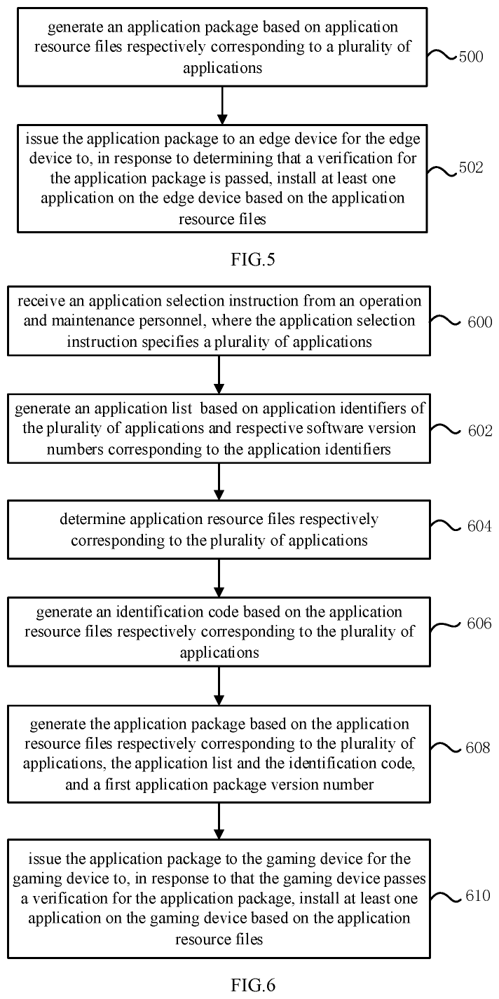

Different gaming devices have different applications running thereon due to different hardware models and different game rules. The operation and maintenance personnel of the gaming place can construct and distribute corresponding application packages in the cloud according to the requirements of different gaming devices in advance, as shown in FIG. 6, which can include the following steps:

At step 600, an application selection instruction is received from an operation and maintenance personnel, where the application selection instruction specifies a plurality of applications.

In this step, the operation and maintenance personnel can send a selection instruction to the cloud through a human-computer interface to select the plurality of applications used on a gaming device. The plurality of applications include a first application and a second application that have a dependency relationship. In addition, after receiving the application selection instruction, the cloud adds other applications that the application depends on to the plurality of applications.

At step 602, an application list is generated based on respective application identifiers of the plurality of applications and respective software version numbers corresponding to the application identifiers.

At step 604, application resource files respectively corresponding to the plurality of applications are determined.

In this step, all application resource files can also be packaged to construct an application resource directory.

At step 606, an identification code is generated based on the application resource files respectively corresponding to the plurality of applications.

In this step, the application resource files can be calculated according to an algorithm agreed with the edge device in advance to generate the identification code.

At step 608, the application package is generated based on the application resource files respectively corresponding to the plurality of applications, the application list and the identification code, and a first application package version number is generated.

The first application package version number identifies the application package, and the last digit of the version number of the application package generated last time in the cloud can be incremented by 1. For example, the version number of the application package generated last time is v0.0005, and the version number of the application package generated this time can be v0.0006.

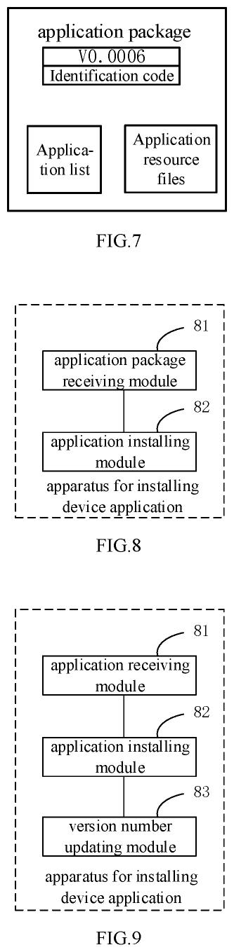

The final application package can be shown in FIG. 7.

At step 610, the application package is issued to the gaming device for the gaming device to, in response to that the gaming device passes a verification for the application package, install at least one application on the gaming device based on the application resource files.

According to the needs of the gaming device, the application package is issued to the corresponding game device. After the game device receives the application package, it first compares the first application package version number of the application package with a local second application package version number. In a case that the first application package version number and the local second application package version number are different, the application package is parsed to obtain the identification code, the application list, and the application resource files. The application resource files are calculated by a algorithm agreed with the cloud in advance, and the obtained verification code is compared with the identification code. If the two are consistent, read the application list to learn the applications and the corresponding version numbers that need to be installed or upgraded this time. Compared with the local default, corresponding resource files are read and installed. After the installation is complete, the first application package version number is recorded as the identifier of the last application package used by the device that is, the local second application package version number.

In the embodiments of the present disclosure, the cloud in the gaming place uses a first application package version number to manage a plurality of application versions installed on different gaming devices, thereby effectively isolating the software version numbers of the applications used by the gaming devices under different demand scenarios. The cloud issues an application package to the gaming device. After the verification is passed, the gaming device automatically traverses an application list to obtain the applications that needs to be installed, and installs the local default application version in batches, which can improve the efficiency of installing and deploying software on the gaming device. For a demand scenario of the gaming dive, the cloud only needs to maintain one first application package version number and does not need to care about the separate software version number of each application version, which greatly reduces confusion and errors and improves the accuracy of installation.

The embodiments of the present disclosure provide an apparatus for installing device application, which can be deployed on an edge device.

As shown in FIG. 8, the apparatus may include: an application package receiving module 81 and an application installing module 82.

The application receiving module 81 is configured to receive an application package issued by a cloud, wherein the application package includes application resource files respectively corresponding to a plurality of applications.

The application installing module 82 is configure to, in response to determining that a verification for the application package is passed, install at least one application on the edge device based on the application resource files.

According to the apparatus for installing device application provided by the embodiments of the present disclosure, an application package is issued through a cloud and applications are installed in batches after verified by an edge device. The edge device only needs to install based on one application package, which can improve the efficiency of installing and deploying software on the device.

In an example, the application package further includes an application list and the application list includes: application identifiers of the plurality of applications and respective software version numbers corresponding to the application identifiers; when the application installing module 82 is configured to install the at least one application on the edge device based on the application resource files, including: traversing each of the application identifiers in the application list, and comparing a first version number with a second version number which are correspond to the application identifier, wherein the first version number is a software version number of a local application corresponding to the application identifier, and the second version number is a software version number corresponding to the application identifier in the application list; in response to the first version number being different from the second version number, obtaining and installing an application resource file corresponding to the application identifier from the application package, so as to upgrade the local application to an application corresponding to the second version number.

In an example, the application package further includes: an identification code which is generated based on the application resource files, when the application installing module 82 is configured to determine that the verification for the application package is passed, including: obtaining a verification code based on the application resource files of the application package; in response to the verification code being consistent with the identification code, determining that the verification for the application package is passed.

In an example, the application package further includes a first application package version number for identifying the application package; when the application installing module 82 is configured to determine that the verification for the application package is passed, including: in response to the first application package version number being different from a local second application package version number of the edge device, determining that the verification for the application package is passed, and the second application package version number is an identifier of an application package received by the edge device last time.

In an example, as shown in FIG. 9, the apparatus further includes a version number updating module 83, configured to update the local second application package version number of the edge device to the first application package version number.

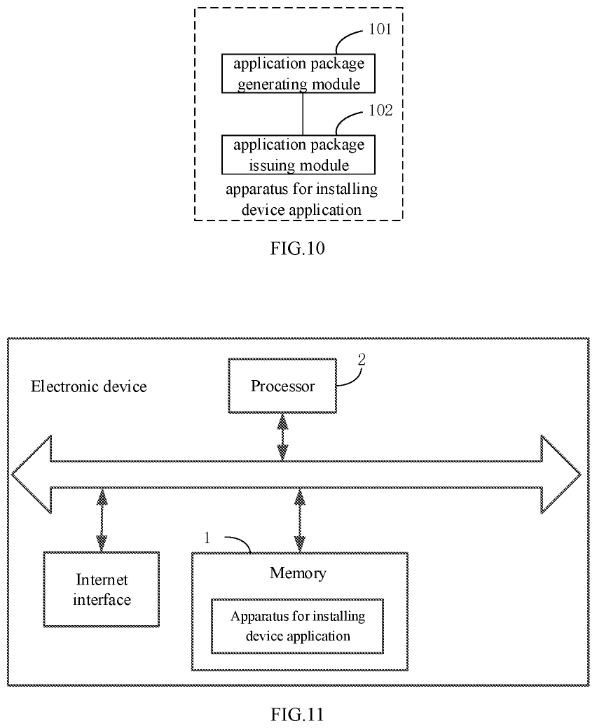

The embodiments of the present disclosure provide another apparatus for installing device application, which can be deployed on a cloud. As shown in FIG. 10, the apparatus may include: an application package generating module 101 and an application package issuing module 102.

The application package generating module 101 is configured to generate an application package based on application resource files respectively corresponding to a plurality of applications.

The application issuing module 102 is configured to issue the application package to an edge device for the edge device to, in response to determining that a verification for the application package is passed, install at least one application on the edge device based on the application resource files.

According to the apparatus for installing device application provided by the embodiments of the present disclosure, an application package is issued through a cloud and applications are installed in batches after verified by an edge device. The edge device only needs to install based on one application package, which can improve the efficiency of installing and deploying software on the device.

In an example the application package generating module 101 is specifically configured to: generate an application list based on respective application identifiers of the plurality of applications and respective software version numbers corresponding to the application identifiers; and generate the application package based on the application list and the application resources files.

In an example, the application package generating module 101 is specifically configured to: generate an identification code based on the application resource files respectively corresponding to the plurality of applications; and generate the application package based on the identification code and the application resource files respectively corresponding to the plurality of applications.

In an example, the application package generating module 101 is specifically configured to: generate a first application package version number corresponding to the application package, wherein the first application package version number identifies the application version number and generate the application package based on the first application package version number and the application resource files respectively corresponding to the plurality of applications.

In an example, the plurality of applications include a first application and a second application with a dependency relationship; the application package generating module 101 is specifically configured to: generate the application package based on at least one application resource file corresponding to the first application and at least one application resource file corresponding to the second application.

For the implementation process of the functions and roles of each module in the above-mentioned apparatus, refer to the implementation process of the corresponding steps in the above-mentioned method for details, which will not be repeated here.

The embodiments of the present disclosure also provide an electronic device. As shown in FIG. 11, the electronic device includes a memory 1, a processor 2, wherein the memory 1 is configured to store computer instructions that can run on the processor. When the computer instructions are executed by the processor 2, the method of installing device application according to any of the embodiments of the present disclosure is implemented.

The embodiments of the present disclosure also provide a computer program product, including a computer program/instruction, wherein when the computer program/instruction is executed by a processor, the method of installing device application according to any of the embodiments of the present disclosure is implemented.

The embodiments of the present disclosure also provide a computer readable storage medium, having a computer program stored thereon, wherein in a case that the computer program is executed by a processor, the method of installing device application according to any of the embodiments of the present disclosure is implemented.

The description of various embodiments of the present disclosure focuses on emphasizing differences between various embodiments, and the same or similar points may be referred to each other. For simplicity, the same or similar parts will not be described herein again.

Since the apparatus examples substantially correspond to the method examples, a reference may be made to part of the descriptions of the method examples for the related part. The apparatus examples described above are merely illustrative, where the modules described as separate members may be or not be physically separated, and the members displayed as modules may be or not be physical units, i.e., may be located in one place, or may be distributed in a plurality of network modules. Part or all of the modules may be selected according to actual requirements to implement the objectives of the solutions in the disclosure. Those of ordinary skill in the art may understand and carry out them without creative work.

The foregoing describes specific embodiments of this specification. Other embodiments are within the scope of the appended claims. In some cases, the actions or steps described in the claims may be performed in a different order than in the embodiments and still achieve desired results. Moreover, the processes depicted in the figures are not necessarily the particular order or order shown to achieve the desired results. In some implementations, multitasking and parallel processing may be advantageous.

Other implementations of the present disclosure will be apparent to those skilled in the art from consideration of the present disclosure and practice of the present disclosure herein. The present disclosure is intended to cover any variations, uses, modification or adaptations of the present disclosure that follow the general principles thereof and include common knowledge or conventional technical means in the related art that flowchart not herein are intended in the present disclosure. The present disclosure and embodiments are considered as exemplary only, with a true scope and spirit of the present herein are intended being indicated by the following claims.

It is to be understood that the present disclosure is not limited to the precise structure described above and shown in the accompanying drawings, and that various modifications and changes can be made without departing from the scope thereof. The scope of protection of the present disclosure limited only by the appended claims.

The above description is only preferred examples of the present disclosure, and is not intended to limit the present disclosure, and any modifications, equivalents, improvements, etc., which are made within the spirit and principles of the present disclosure, should be included scope of the present disclosure.

1. A method of installing device application, being applicable in an edge device, comprising:
receiving an application package issued by a cloud, wherein the application package comprises application resource files respectively corresponding to a plurality of applications; and
in response to determining that a verification for the application package is passed, installing at least one application on the edge device based on the application resource files.

2. The method of claim 1, wherein the application package further comprises an application list comprising application identifiers of the plurality of applications and respective software version numbers corresponding to the application identifiers, installing at least one application on the edge device based on the application resource files comprises:
traversing each of the application identifiers in the application list and further
comparing a first version number with a second version number which are correspond to the application identifier, wherein the first version number is a software version number of a local application corresponding to the application identifier, and the second version number is a software version number corresponding to the application identifier in the application list;
in response to the first version number being different from the second version number, obtaining and installing an application resource file corresponding to the application identifier from the application package, so as to upgrade the local application to an application corresponding to the second version number.

3. The method of claim 1, wherein the application package further comprises an identification code which is generated based on the application resource files in the application package, determining the verification for the application package is passed comprises:
obtaining a verification code based on the application resource files of the application package;
in response to the verification code being consistent with the identification code, determining the verification for the application package is passed.

4. The method of claim 1, wherein the application package further comprises a first application package version number for identifying the application package, determining that the verification for the application package is passed comprises:
in response to the first application package version number being different from a local second application package version number of the edge device, determining that the verification for the application package is passed, wherein the second application package version number is an identifier of an application package received by the edge device last time.

5. The method of claim 4, wherein determining that the verification for the application package is passed further comprises:
updating the local second application package version number of the edge device to the first application package version number.

6. A method of installing device application, being applicable in a cloud, comprising:
generating an application package based on application resource files respectively corresponding to a plurality of applications; and
issuing the application package to an edge device for the edge device to, in response to determining that a verification for the application package is passed, install at least one application on the edge device based on the application resource files.

7. The method of claim 6, wherein generating the application package based on the application resource files respectively corresponding to the plurality of applications comprises:
generating an application list based on respective application identifiers of the plurality of applications and respective software version numbers corresponding to the application identifiers; and
generating the application package based on the application list and the application resources files.

8. The method of claim 6, wherein generating the application package based on the application resource files respectively corresponding to the plurality of applications comprises:
generating an identification code based on the application resource files respectively corresponding to the plurality of applications; and
generating the application package based on the identification code and the application resource files respectively corresponding to the plurality of applications.

9. The method of claim 6, wherein generating the application package based on the application resource files respectively corresponding to the plurality of applications comprises:
generating a first application package version number corresponding to the application package, wherein the first application package version number identifies the application version number; and
generating the application package based on the first application package version number and the application resource files respectively corresponding to the plurality of applications.

10. The method of claim 6, wherein the plurality of applications comprise a first application and a second application with a dependency relationship, generating the application package based on the application resource files respectively corresponding to the plurality of applications comprises:
generating the application package based on at least one application resource file corresponding to the first application and at least one application resource file corresponding to the second application.

11. An electronic device, comprising a processor, and a memory storing computer instructions executable on a processor, when the computer instructions are executed by the processor, a method of installing device application is implemented, the method comprising:
receiving an application package issued by a cloud, wherein the application package comprises application resource files respectively corresponding to a plurality of applications; and
in response to determining that a verification for the application package is passed, installing at least one application on the edge device based on the application resource files.

12. The electronic device of claim 11, wherein the application package further comprises an application list comprising application identifiers of the plurality of applications and respective software version numbers corresponding to the application identifiers, installing at least one application on the edge device based on the application resource files comprises:
traversing each of the application identifiers in the application list and further
comparing a first version number with a second version number which are correspond to the application identifier, wherein the first version number is a software version number of a local application corresponding to the application identifier, and the second version number is a software version number corresponding to the application identifier in the application list;
in response to the first version number being different from the second version number, obtaining and installing an application resource file corresponding to the application identifier from the application package, so as to upgrade the local application to an application corresponding to the second version number.

13. The electronic device of claim 11, wherein the application package further comprises an identification code which is generated based on the application resource files in the application package, determining the verification for the application package is passed comprises:
obtaining a verification code based on the application resource files of the application package;
in response to the verification code being consistent with the identification code, determining the verification for the application package is passed.

14. The electronic device of claim 11, wherein the application package further comprises a first application package version number for identifying the application package, determining that the verification for the application package is passed comprises:
in response to the first application package version number being different from a local second application package version number of the edge device, determining that the verification for the application package is passed, wherein the second application package version number is an identifier of an application package received by the edge device last time.

15. The electronic device of claim 14, wherein determining that the verification for the application package is passed further comprises:
updating the local second application package version number of the edge device to the first application package version number.
